(19) United States
(12) Patent Application Publication
(10) Pub. No.: US 2012/0250767 A1
(43) Pub. Date: Oct. 4, 2012

(54) METHOD AND APPARATUS FOR BI-DIRECTIONAL PREDICTION WITHIN P-SLICES

(76) Inventors: Ferran Valldosera, Princeton, NJ (US); Hua Yang, Princeton, NJ (US); Gad Berger, Dayton, NJ (US)

(21) Appl. No.: 13/516,269

(22) PCT Filed: Dec. 15, 2009
(86) PCT No.: PCT/US2009/006546

§ 371 Date: Jun. 15, 2012

(51) Int. Cl. H04N 7/32

(52) U.S. Cl. 375/240.15; 375/E07.243; 375/E07.125

(57) ABSTRACT

Method and apparatuses are provided to enable bi-directional prediction (or bi-prediction) within P slices. A bi-predicted P slice is introduced herein as a new slice type in addition to existing I, P and B slices. A benefit of the new bi-predicted P slice is that it enables a video encoder to support temporal scalability without the need to use B pictures. Bi-predicted P slices enable the definition of a hierarchical GOP structure, which is a common method to allow temporal scalability in a video encoder. Another advantage of bi-predicted P slices is that it can improve coding efficiency over uni-directional P slices for some particular video content frames.

### FIELD OF THE INVENTION

The present invention relates to video encoding. More particularly, it relates to a method and apparatus for enabling bi-directional prediction in P slices during video encoding.

### BACKGROUND OF THE INVENTION

Those of skill in the video encoding arts recognize that some video formats do not allow B slices in their basic profiles. For example, H.264 does not allow B slices in Baseline profile. Another example is Scalable Video Coding (SVC), which does not allow B slices in its base layer, as it should conform to H.264/AVC Baseline profile. The inability to employ bi-prediction for these profiles encumbers desired features like hierarchical GOP structures, which provide temporal scalability and also may improve coding efficiency.

### SUMMARY OF THE INVENTION

Various described embodiments of the present invention address the deficiencies of the prior art by approximating the coding behavior of B slices but still making use of P slices syntax through a new slice type: bi-predicted P slices. A benefit is that temporal scalability can be provided by defining a GOP based on hierarchical P pictures, which would employ bi-predicted P slices. In addition, some coding efficiency improvement can be obtained by employing bi-directional prediction instead of uni-directional prediction in P pictures (i.e., dissolves, occlusions, non-linear motion, etc).

One embodiment of the present invention includes a method for a video encoder which enables bi-directional prediction (or bi-prediction) within P slices, which in principle only allow uni-directional prediction, usually forward prediction. A bi-predicted P slice is defined as a new slice type in addition to existing I, P and B slices. One benefit of this new slice type is that it enables a video encoder to support temporal scalability without the need to use B pictures. Bi-predicted P slices allow defining a hierarchical GOP structure, which is a common method to allow temporal scalability in a video encoder. Another advantage of bi-predicted P slices is that it can improve coding efficiency over uni-directional P slices for some particular video content frames in a similar way B slices also do over P slices.

In one embodiment, a method for encoding a video bitstream in accordance with the present invention includes selecting a bi-predicted P-slice for encoding, determining a prediction mode for the selected bi-predicted P-slice, and encoding the bi-predicted P-slice with the determined prediction mode. The determining of a prediction mode can include calculating motion vector predictors for macroblocks neighboring a macroblock selected from the bi-predicted P-slice.

In an alternate embodiment of the present invention, the determining of a prediction mode further includes calculating motion vectors from the calculated motion vector predictors, determining prediction blocks from the calculated motion vectors, and calculating a cost measure for determined prediction blocks, the encoding being based on the lowest cost measure determined for the selected bi-predicted P slice.

In an alternate embodiment, a video encoder includes a reference picture selector in signal communication with a reference pictures store, a motion compensation module and a motion estimation module. The reference picture selector is configured to receive a frame type designation as an input. The reference picture selector and reference pictures store enable the use and selection of bi-prediction in P-slices.

In an alternate embodiment, the video encoder includes a processor and a memory in communication with the processor, where the processor is configured to determine a prediction mode based on a determination as to the lowest cost measure to select forward or prediction mode for each macroblock within a selected bi-predicted P slice. The processor is further configured to determine a frame type for all frames within a GOP such that the determined frame type operates as the input of the reference picture selector.

### BRIEF DESCRIPTION OF THE DRAWINGS

The teachings of the present invention can be readily understood by considering the following detailed description in conjunction with the accompanying drawings, in which:

FIG. 1 depicts a flow diagram of a method for an encoding process of a GOP for bi-directional prediction with P slices in accordance with an embodiment of the present invention;

FIG. 2 depicts a high level block diagram of a video encoder implementing the encoding process for bi-directional prediction with P slices in accordance with an embodiment of the present invention;

FIG. 3a depicts an example of forward prediction used for P slices in accordance with an embodiment of the present invention;

FIG. 3b depicts an example showing the use of forward and backward prediction for bi-predicted P slices in accordance with an embodiment of the present invention;

FIG. 4a depicts a flow diagram of a decision process of the optimal prediction mode for a macroblock within a bi-predicted P slice in accordance with an embodiment of the present invention;

FIGS. 4b-4e depict more detailed examples of the decision process of the prediction mode for a macroblock within a bi-predicted P slice shown in FIG. 4a in accordance with an embodiment of the present invention; and

FIGS. 5a-5c depict graphical representations of reference pictures and prediction directions for three exemplary bi-predicted pictures in a simplified hierarchical GOP structure in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides methods and an apparatus for encoding a video bitstream in a video encoding environment including the use of bi-predicted P slices in accordance with embodiments of the present invention. Although the present invention may be described primarily within the context of the H.264 standard as the video format in use, the specific embodiments of the present invention should not be treated as limiting the scope of the invention. It will be appreciated by those skilled in the art and informed by the teachings of the present invention that the concepts of the present invention can be advantageously applied to substantially any video format. For the sake of simplicity in the examples described herein, the number of past and future reference pictures is limited to one (1) for each case. However, extending the principles of the embodiments of the present invention to multiple-reference cases (in any or both temporal directions) is not only feasible but can further improve coding efficiency for some particular video sequences.

It will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

It should be noted that inter-coded macroblocks can be predicted from one or two reference pictures from a list 0 (P and B slices) and/or a list 1 (B slices only). These reference pictures correspond to previously coded and reconstructed pictures, and can be from before or after the current picture in temporal order. Both lists can contain past and/or future coded pictures and can be marked as short-term or long-term reference pictures. Each reference picture can have one or more reference picture indices, which are used to signal what reference picture has been used to encode a macroblock. If the reference picture used for prediction corresponds to a past coded picture in temporal order we refer to the employed prediction mode as Forward Prediction. If a future coded picture is used for prediction, then we refer to it as Backward Prediction.

### Bi-prediction in B Slices

B slices contain B macroblocks, which are either intra or inter-coded. Inter-coded B macroblocks can be predicted in different ways: direct mode; motion-compensated prediction from a list 0 reference picture; motion-compensated prediction from a list 1 reference picture; or motion-compensated bi-predicted from a list 0 and a list 1 reference pictures. In fact, inside a macroblock, different partitions may be encoded with different prediction options (i.e., 16×8, 8×16 or 8×8 blocks may use different prediction). Except for direct mode, the decision of which prediction mode is used to encode a macroblock is based on a cost measure calculated for the three prediction modes: forward, backward and bi-predictive modes. The mode with the minimum cost is the one selected to encode the current B macroblock. In the exemplary implementation of the invention, the cost is calculated based on a Rate-Distortion (RD) measure which depends on the distortion of the prediction and a weighted factor of the number of bits used to encode the Motion Vector. The distortion is measured with the Sum of Absolute Difference (SAD) calculation, but can be represented with other similar difference calculations.

Bi-predictive (i.e., bi-directional prediction) mode in B slices requires two motion vectors from two reference blocks. The blocks are of the same size as the current partition and are from list 0 and list 1. The prediction block is generated by averaging list 0 and list 1 prediction samples. It should be noted that different weights are used when Weighted Prediction is used.

pred(i,j)=(pred0(i,j)+pred1(i,j)+1)/2

### Temporal Scalability and Hierarchical GOP Structures

According to implementations of Hierarchical B pictures, improvements of up to 1.5 dB can be shown in comparison to classical coding structures like IBBP, which is a GOP consisting of one Infra picture followed by two B pictures and one P in display order. In addition, hierarchical B pictures improve subjective visual quality, especially for sequences with fine-detailed slow/regular moving image regions. However, these results give an idea of the benefits that bi-prediction can provide to a video encoder implementing a profile where bi-prediction was not initially allowed.

It is understood that a video encoder does not require B pictures or bi-predicted pictures to provide temporal scalability. An example of an implementation of a video encoder that provides Temporal scalability without B pictures is described in the published article entitled “Temporal scalability using P-pictures for low-latency applications”, by Wenger, S, published in the 1998 IEEE Second Workshop on Multimedia Signal Processing, and it is based on a low-latency multi-layer GOP structure, in which a base layer uses I and P pictures while an enhancement layer uses only P pictures, which can be predicted from previous pictures from the enhancement or the base layer.

Using P pictures with forward prediction instead of B pictures with bi-prediction allows for decreased latency, since forward predicted P pictures do not need a future reference picture to be previously decoded. Another advantage is that error resiliency is improved, but this is also true for GOPs containing hierarchical B pictures. Its main disadvantage is a loss in coding efficiency due to lack of bi-prediction.

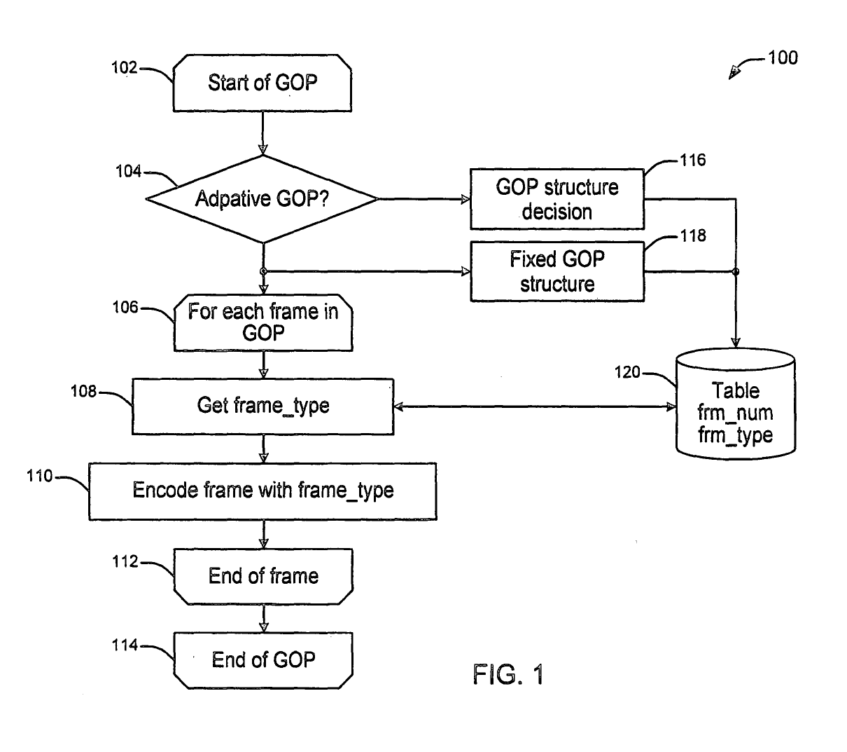

FIG. 1 depicts a flow diagram of a method 100 for an encoding process of a group of pictures (GOP) for bi-directional prediction with P slices in accordance with an embodiment of the present invention. As depicted in FIG. 1, the method 100 begins at step 102 during which the GOP structure is defined. The method 100 then proceeds to step 104.

At step 104, a determination is made whether the GOP is adaptive. Here, an adaptive GOP is referred to a GOP where the frame types of the frames inside the GOP are not predefined by a fixed pattern (e.g. a fixed GOP). Thus, a video encoder implementing an adaptive GOP feature requires a module that decides the frame types of all the frames in the GOP. One motivation for implementing such adaptive GOPs is that coding efficiency is usually improved by using adaptive GOPs instead of fixed GOPs.

If, at step 104, the GOP is determined to be adaptive, the method 100 proceeds to step 116 during which the GOP structure decision module determines the frame type for each frame in the GOP and sends the same to the Table 120 (which can be any suitable storage facility or device).

If, at step 104, the GOP is not determined to be adaptive, the method 100 proceeds to step 118 during which the GOP is identified as fixed. In a fixed GOP structure, the frame type follows a fixed pattern. The method then proceeds to step 106.

At step 106, for each frame in the GOP, the method proceeds to step 108. At step 108, the frame type is obtained from the table 120. The method 100 then proceeds to step 110.

At step 110, the GOP is encoded with the identified frame type. More specifically, it is at a GOP decision structure module of step 116 where the determination is made whether or not to use the bi-Predicted P frames (for an adaptive GOP case) of the present invention, and at step 118 where a decision module decides which frames are used in a fixed GOP case.

The method 100 ends at step 112 for each frame and at step 118 for a GOP.

### Bi-Predicted P Frame Type Decision

Depending on the configuration of a video encoder and the types of GOP structures it allows to define, the decision of frame types can vary. For example, a common scenario is a fixed-GOP structure (step 118 of FIG. 1), in which the number of bi-Predicted P frames can be initially defined through a settings parameter and an encoder would follow that structure without any necessary frame-type decision. For a non-fixed GOP structure case, a frame type decision module (step 116) decides whether to encode a frame as a P frame or as a bi-Predicted P frame, enabling the improvement of coding efficiency over a fixed-GOP structure.

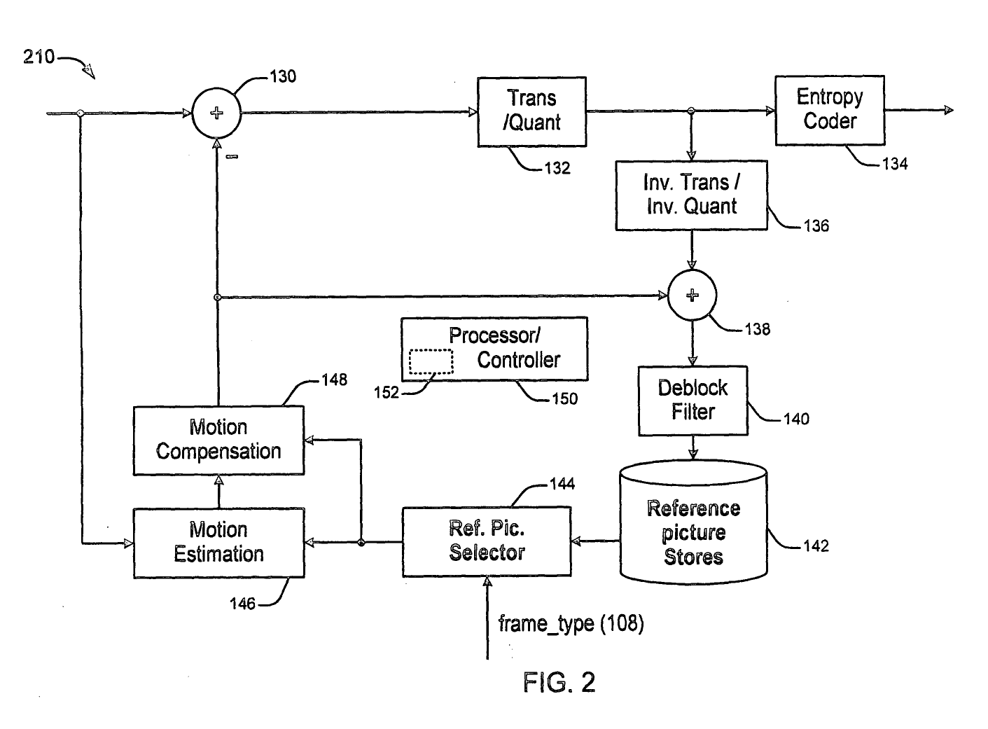

FIG. 2 depicts a high level block diagram of a video encoder implementing the encoding process for bi-directional prediction with P slices in accordance with an embodiment of the present invention. Illustratively, in FIG. 2 only minor modifications to the standard video encoder are required to implement the bi-predicted P slice according to an embodiment of the present invention. As depicted in FIG. 2, a processor/controller 150 can include either an onboard or off board memory 152 and is in communication with all elements of the encoder 210.

An input to the video encoder 210 is connected in signal communication with a non-inverting input of a summing junction 130. The output of the summing junction 130 is connected in signal communication with a transformer/quantizer 132. The output of the transformer/quantizer 132 is connected in signal communication with an entropy coder 134. An output of the entropy coder 134 is available as an output of the encoder.

The output of the transfer/quantizer 132 is further connected in signal communication with an inverse transformer/quantizer 136. An output of the inverse transformer/quantizer 136 is connected in signal communication with a summing junction 138 which also receives an input from an output of the motion compensator 148. The output of the summing junction 138 is connected in signal communication with an input of the deblock filter 140. An output of the deblock filter 140 is connected in signal communication with reference pictures stores 142. The reference pictures stores 142 (e.g., decoded picture buffer—DPB) is in bi-directional communication with the reference picture selector 144 which receives the frame_type (step 108 in FIG. 1) as an input. The output of the reference picture selector 144 is an input to both the motion estimator 146 and the motion compensator 148. The input of the encoder 210 is connected in signal communication with the motion estimator 146. As will be described below, the reference picture selector 144 and reference pictures store 142 (DPB) enable the use and selection of bi-predicted P slices in accordance with an embodiment of the present invention.

### Bi-Prediction in P Slices

P slices contains P macroblocks, which are either intra or inter-coded. Inter-coded P macroblocks are predicted from one reference picture in list 0 using uni-directional prediction, usually forward prediction. All macroblocks within the same P slice use the same prediction mode. Such a constraint is modified in the described new slice type of the various embodiments of the present invention, in which macroblocks within the same slice can use forward or backward prediction modes.

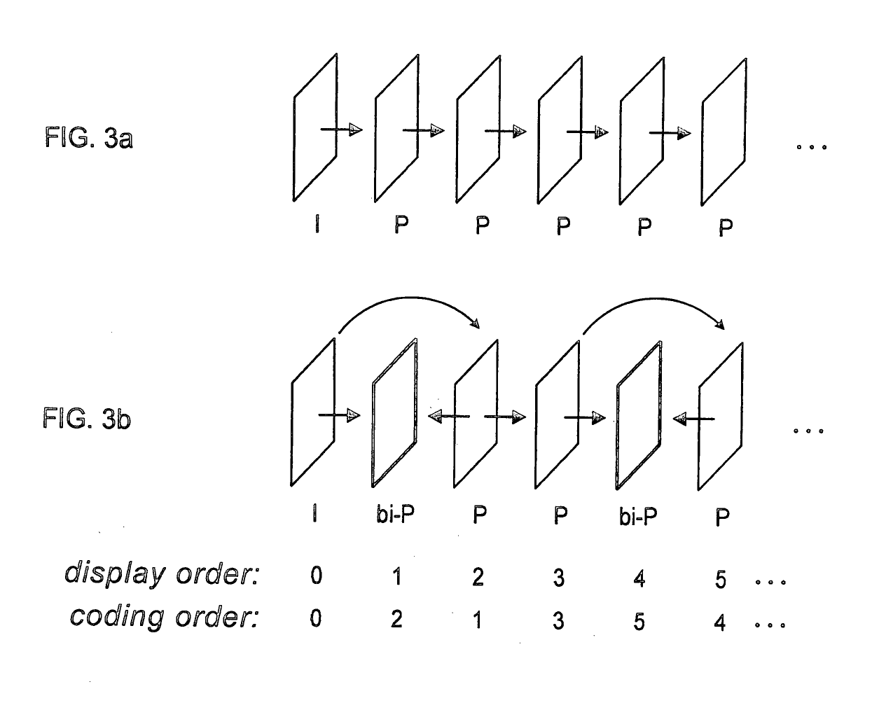

In accordance with the present invention, the prediction direction is decided individually based on a criteria described below. That is, in bi-predicted P frames of the present invention, there can be a mismatch between the display order and the coding order to assure that each picture to be encoded has already encoded its necessary reference pictures. FIGS. 3a and 3b illustrate such mismatch in the case of using bi-predicted P slices of the present invention. More specifically, FIG. 3a depicts an example of forward prediction used for P slices, while FIG. 3b depicts an example showing the use of forward and backward prediction for bi-predicted P slices in accordance with an embodiment of the present invention. As is depicted in FIG. 3b, in accordance with the present invention, the coding order is different than the display order for bi-predicted P slices versus forward predicted P slices. That is, as depicted in FIG. 3b, for the bi-predicted P pictures of the present invention, illustratively pictures 1 and 4 of the GOP of FIG. 3b, pictures 0 and 2 are first decoded to ensure the proper decoding of the bi-predicted P picture 1 and then pictures 3 and 5 are decoded to ensure the proper decoding of the bi-predicted P picture 4.

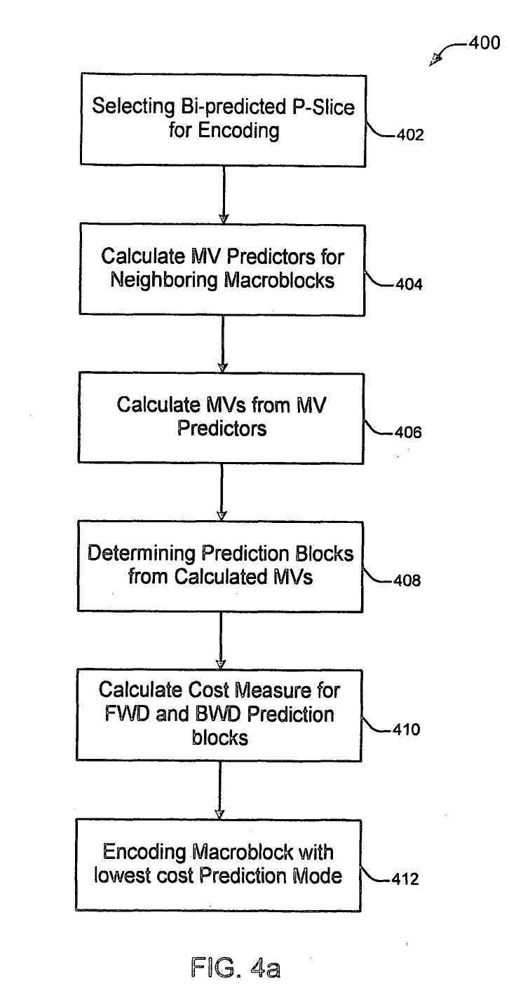

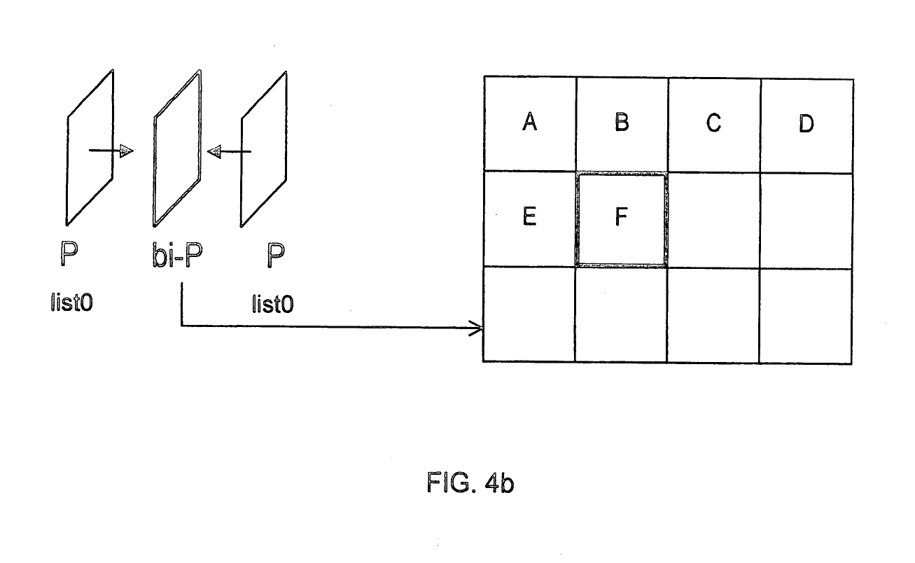

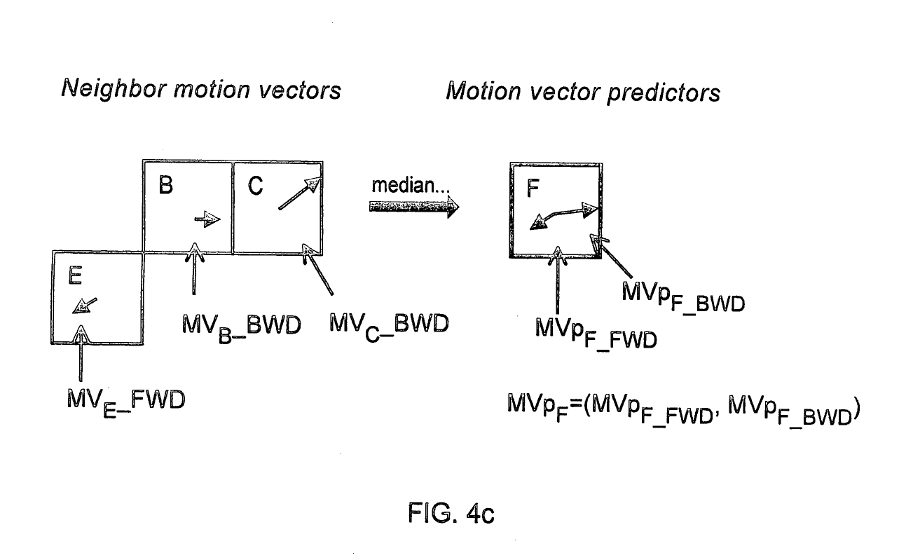

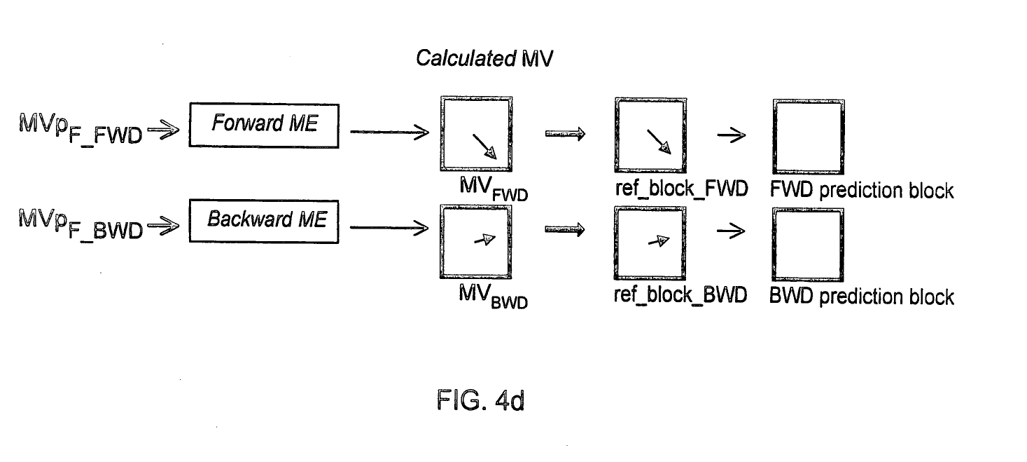

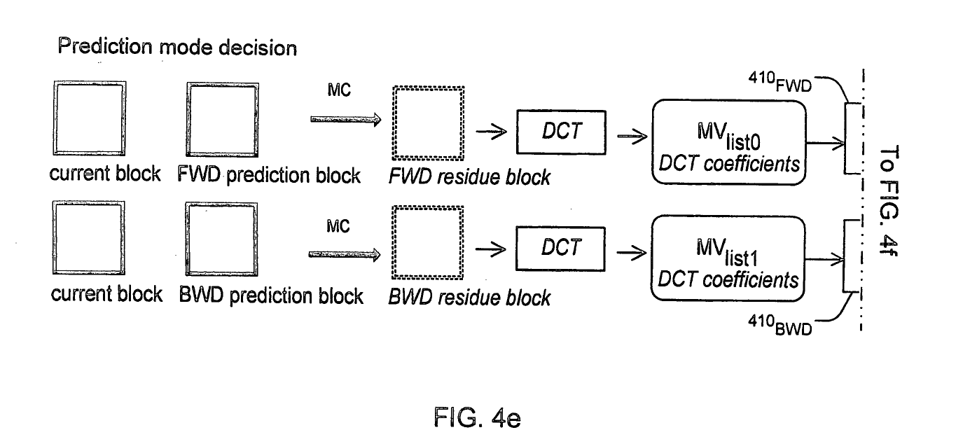

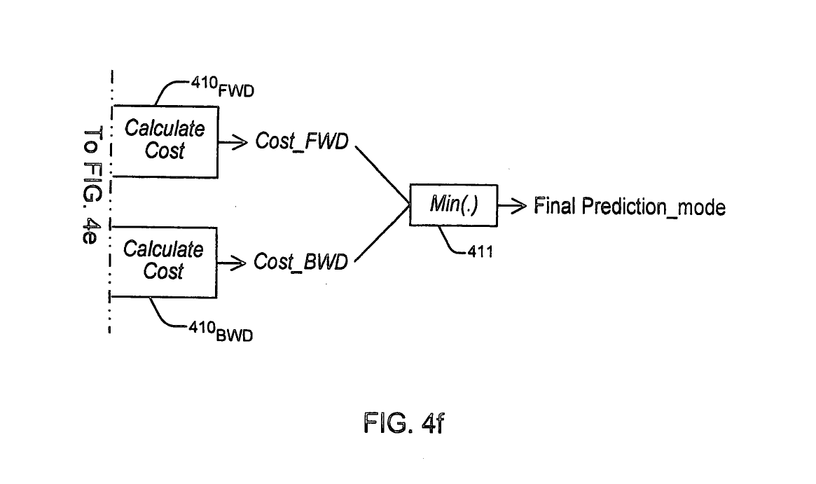

FIG. 4a depicts a flow diagram of a decision process of the optimal prediction mode for a macroblock within a bi-predicted P slice in accordance with an embodiment of the present invention, while FIGS. 4b-4e depict more detailed examples of the decision process of the prediction mode for a macroblock within a bi-predicted P slice shown in FIG. 4a in accordance with an embodiment of the present invention. That is, the process to decide the prediction mode employed for encoding a P macroblock within a bi-predicted P slice is depicted in FIGS. 4a-4e. In the examples, it is assumed that a frame type decision module (associated with step 116 of FIG. 1) decides whether a P or bi-predicted P slice is used for encoding the current picture. More details on the operation of a GOP structure decision module in accordance with the present invention are described below. The Motion Estimation (ME) module 146 of FIG. 2 makes use of the decision to select the best motion vector candidate with the least amount of cost.

As previously described, FIG. 4a depicts a method 400 for determining the prediction mode employed for encoding a P macroblock within a bi-predicted P slice according to an embodiment of the present invention. The method 400 of FIG. 4a, begins at step 402 during which it is determined that a bi-predicted P-slice will be used for encoding. The method 400 then proceeds to step 404.

At step 404, then the motion vector (MV) predictors for neighboring macroblocks are calculated. The method 400 then proceeds to step 406.

At step 406, using the calculated MV predictors, the motion vectors are calculated. The method 400 then proceeds to step 408.

At step 408, once the MVs are calculated, the prediction blocks are determined. The method 400 then proceeds to step 410.

At step 410, a cost measure for both FWD and BWD prediction blocks is calculated. The method 400 then proceeds to step 412.

At step 412, once the cost measure is determined, the macroblock is encoded with the lowest cost prediction mode.

FIG. 4b illustrates a macroblock, F, within a bi-predicted P slice (bi-P). FIG. 4c illustrates that if a bi-predicted P slice type is selected, each motion vector predictor will be calculated (step 404) from its neighboring P macroblocks with motion vectors matching the same temporal direction as the target motion vector predictor. That is, FIG. 4c depicts a graphical representation of when the motion vectors are taken from the neighboring macroblocks E, B and C. It is similar to the case of B macroblocks, where two motion vector predictors are calculated, one from a past reference picture using forward prediction, MVₚ_{_{—}}_{FWD}, and one from a future reference picture using backward prediction, MVₚ_{_{—}}_{BWD}.

As depicted in FIG. 4d, the ME module 146 of FIG. 1 then uses the determined motion vector predictors MVₚ_{_{—}}_{FWD} and MVₚ_{_{—}}_{BWD} to calculate (step 406 of method 400) the actual two motion vectors, again one from a past reference picture MV_{FWD} and one from a future reference picture MV_{BWD}. By pointing to each reference picture with the calculated motion vectors, two prediction blocks are obtained/determined (step 408 of method 400); FWD prediction block and BWD prediction block. FIG. 4e depicts the prediction mode decision where, as in B macroblocks, a cost measure is calculated (step 410 of method 400) for both the forward and backward predictions. The difference is that for P macroblocks, the bi-predictive mode is not allowed and thus it is not calculated. Finally the prediction mode with minimum cost is used (step 411 of method 400—Final Prediction_mode) in the encoding (step 412 of method 400) of the macroblock.

Note that the syntax of a P macroblock encoded within a default (forward) P slice or within a bi-predicted P slice is the same. Only the values of the macroblock header can differ (reference picture index, motion vector, mode, etc).

As mentioned earlier, P slices usually employ forward prediction for all of its macroblocks. The standard (i.e., H.264) does not specify which direction should be employed for a given slice, as it only requires a concrete syntax which includes, among others, one motion vector and one reference picture index per macroblock (or partition block). Therefore, it is the responsibility of a video encoder to decide what prediction mode is more efficient. One advantage of the proposed bi-prediction P slice of the present invention is that it can be considered a generalized approach that eases this decision process as it inherently checks both prediction modes.

In accordance with various embodiments of the present invention, in order to implement bi-predicted P slices of the present invention, a video encoder, such as the video encoder 210 of FIG. 2, should include
A frame-type (or slice type) decision module to decide if a frame (slice) will use bi-prediction. In the example of FIG. 2, the frame type decision module is part of the processor 150 and corresponding memory 152:
A GOP structure generation module (i.e., see GOP decision method 100 steps 104, 116, 118 in FIG. 1) that, given the frame types of the frames of a GOP, properly sets their coding order to assure that bi-predicted frames have past and future reference pictures available in the DPB (Decoded Picture Buffer).
A slight modification in the reference picture management modules to allocate at least one additional frame in the DPB to account for future reference pictures employed for bi-predicted P slices. This modification is performed by, in one embodiment, the processor/controller 150, as it is responsible for enforcing the DPB to perform the allocation of the present invention. Also, before encoding each bi-predicted P slice, the number of active reference pictures is increased at least by 1 to not only use past reference pictures but also use at least 1 additional future reference picture.

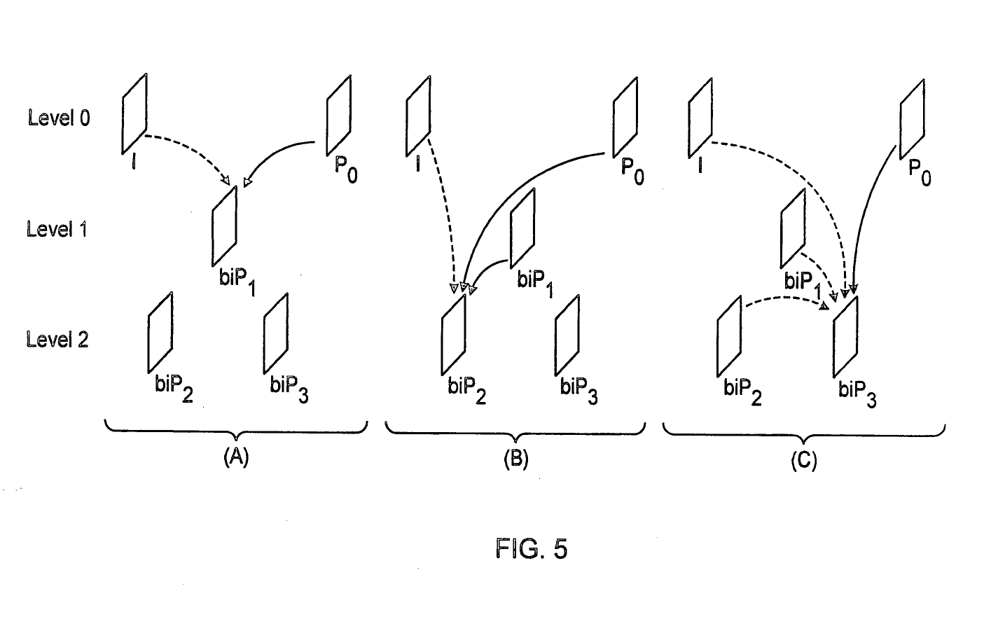

FIGS. 5a-5c depict graphical representations of reference pictures and prediction directions for three exemplary bi-predicted pictures in a simplified hierarchical GOP structure in accordance with an embodiment of the present invention. The examples depict a three-level hierarchical GOP structure of illustratively five pictures (1 I picture, 1 P picture and 3 bi-predicted P pictures). The reference pictures that each bi-predicted P slice can use are illustrated with dashed lines for forward and solid lines for the backward prediction modes. Note that the examples depict a multiple-reference case whereas a single-reference case would allow only one past and one future reference picture for each bi-predicted P slice.

Hierarchical GOP structures of the present invention may or may not introduce decoding delay depending on their structure. For example, dyadic hierarchical structures do introduce a certain amount of delay, which is proportional to the maximum temporal distance between the key pictures. Other forms of hierarchical structures may sacrifice some coding efficiency for decreasing the decoding delay as low as zero. Hence, there is a compromise between decoding delay and coding efficiency when defining the GOP structure and the final decision can depend on the application.

Having described various embodiments for methods and apparatus for encoding a video bitstream including the use of bi-predicted P slices in accordance with embodiments of the present invention (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for encoding a video bitstream, the method comprising the steps of:
determining that a bi-predicted P-slice will be used for encoding;
determining a prediction mode for the selected bi-predicted P-slice; and
encoding the bi-predicted P-slice with the determined prediction mode.

2. The method according to claim 1, wherein said determining a prediction mode further comprises:
calculating motion vector predictors for macroblocks neighboring a macroblock selected from the bi-predicted P-slice.

3. The method according to claim 2, wherein said determining a prediction mode further comprises:
calculating motion vectors from the calculated motion vector predictors;
determining prediction blocks from the calculated motion vectors; and
calculating a cost measure for determined prediction blocks, said encoding being based on the lowest cost measure determined for the selected bi-predicted P slice.

4. The method according to claim 3, wherein said calculating a cost measure comprises calculating the cost measure for determined forward and backward prediction blocks

5. The method according to claim 1, wherein said determining that a bi-predicted P-slice will be used for encoding comprises:
determining a frame type; and
determining the frame types of all frames within a GOP structure from the determined frame type prior to encoding.

6. The method according to claim 1, wherein said determining that a bi-predicted P-slice will be used for encoding enables implementing hierarchical GOP structures and thereby provides temporal scalability of a video bitstream to be encoded.

7. A video encoder comprising:
a reference picture selector in signal communication with a reference pictures store a motion compensation module and a motion estimation module, said reference picture selector configured to receive a frame type designation as an input and wherein the reference picture selector and said reference pictures store enable the use and selection of bi-prediction in P-slices.

8. The video encoder according to claim 7, further comprising a processor and a memory in communication with the processor, said processor configured to determine a prediction mode based on a determination as to the lowest cost measure to select forward or prediction mode for each macroblock within a selected bi-predicted P slice.

9. The video encoder according to claim 8, wherein said processor is further configured to determine a frame type for all frames within a GOP, said determined frame type operating as the input of the reference picture selector.

10. The video encoder according to claim 8, wherein said determination as to the lowest cost measure comprises calculating the cost based on a Rate-Distortion measure.

11. The video encoder according to claim 8 wherein said processor determines the prediction mode by calculating motion vector predictors for macroblocks neighboring a macroblock selected from the bi-predicted P-slice.

12. The video encoder according to claim 8, wherein said processor encodes the bi-predicted P-slice with the determined prediction mode.

13. A video encoder comprising:
means for determining that a bi-predicted P-slice will be used for encoding;
means for determining a prediction mode for the selected bi-predicted P-slice;
means for encoding the bi-predicted P-slice with the determined prediction mode.

14. The video encoder of claim 13, further comprising:
means for calculating motion vector predictors for macroblocks neighboring a macroblock selected from the bi-predicted P-slice.

15. The video encoder of claim 14, further comprising:
means for calculating motion vectors from the calculated motion vector predictors;
means for determining prediction blocks from the calculated motion vectors; and
means for calculating a cost measure for determined prediction blocks, said encoding being based on the lowest cost measure determined for the selected bi-predicted P-slice.

16. The video encoder of claim 14, wherein said means for calculating a cost measure comprises means for calculating the cost measure for determined forward and backward prediction blocks

17. The video encoder of claim 13, further comprising:
means for determining a frame type; and
means for determining the frame types of all frames within a GOP structure from the determined frame type prior to encoding.
